(19) United States
(12) Patent Application Publication
(10) Pub. No.: US 2025/0254136 A1
(43) Pub. Date: Aug. 7, 2025

(54) PLUGGABLE MANAGEMENT MODULES FOR COMPUTING DEVICES

(71) Applicant: Dell Products L.P., Round Rock, TX (US)

(72) Inventors: Padmanabhan Narayanan, Chennai (IN); Vamshidhar Varre, Hyderabad (IN); Narayanaswamy Perumal, Chennai (IN)

(21) Appl. No.: 18/435,164

(22) Filed: Feb. 7, 2024

(51) Int. Cl. H04L 49/00; H04L 49/40

(52) U.S. Cl. CPC H04L 49/30; H04L 49/40

(57) ABSTRACT

An apparatus comprises a housing comprising at least one of one or more out-of-band management (OOBM) ports and one or more OOBM indicators, and a connector coupled to the housing, the connector configured for operable interconnection with a pluggable management module port of a computing device. The apparatus also comprises at least one processing device configured to exchange, with the computing device, configuration information for the OOBM ports and the OOBM indicators, and to receive, from the computing device, OOBM information for controlling operation of the OOBM ports and the OOBM indicators, the OOBM information being based at least in part on a determined operational status of one or more components of the computing device. The at least one processing device is also configured to control, based at least in part on the received OOBM information, operation of the OOBM ports and the OOBM indicators.

### BACKGROUND

Computing devices, including network switches and other types of network devices, may include one or more transceiver ports for transceivers. Such transceivers may be used for interconnecting multiple computing devices. The transceiver ports may support a wide spectrum of data transfer speeds, enabling a range of connectivity options. The transceiver ports may be arranged on a housing of a computing device. For example, a front panel of a network switch may include a plurality of transceiver ports. One or more light-emitting diodes (LEDs) or other light-emitting diodes may be arranged on the housing of the computing device in order to provide various information relating to transceiver ports or other information relating to operation of the computing device.

### SUMMARY

Illustrative embodiments of the present disclosure provide techniques for utilizing pluggable management modules in computing devices.

In one embodiment, an apparatus comprises a housing comprising at least one of (i) one or more out-of-band management ports and (ii) one or more out-of-band management indicators and a connector coupled to the housing, the connector configured for operable interconnection with a pluggable management module port of a computing device. The apparatus also comprises at least one processing device comprising a processor coupled to a memory. The at least one processing device is configured to exchange, with the computing device, configuration information for the at least one of (i) the one or more out-of-band management ports and (ii) the one or more out-of-band management indicators, and to receive, from the computing device, out-of-band management information for controlling operation of the at least one of (i) the one or more out-of-band management ports and (ii) the one or more out-of-band management indicators, the out-of-band management information being based at least in part on a determined operational status of one or more components of the computing device. The at least one processing device is also configured to control, based at least in part on the received out-of-band management information, operation of the at least one of (i) the one or more out-of-band management ports and (ii) the one or more out-of-band management indicators.

In another embodiment, an apparatus comprises one or more pluggable management module ports configured for operable interconnection with one or more pluggable management modules and at least one processing device comprising a processor coupled to a memory. The at least one processing device is configured to detect a given one of the one or more pluggable management modules that is plugged into a given one of the one or more pluggable management module ports, and to exchange, with the given pluggable management module, configuration information for at least one of (i) one or more out-of-band management ports and (ii) one or more out-of-band management indicators which are part of a housing of the given pluggable management module. The at least one processing device is also configured to determine an operational status of one or more components of the apparatus, and to provide, to the given pluggable management module, out-of-band management information for controlling operation of the at least one of (i) the one or more out-of-band management ports and (ii) the one or more out-of-band management indicators which are part of the housing of the given pluggable management module, the out-of-band management information being based at least in part on the determined operational status of the one or more components of the apparatus.

In another embodiment, a system comprises a computing device comprising two or more pluggable management module ports, a first pluggable management module configured for insertion into a first one of the two or more pluggable management module ports, and a second pluggable management module configured for insertion into a second one of the two or more pluggable management module ports. The first pluggable management module comprises a first set of at least one of one or more out-of-band management ports and one or more out-of-band management indicators, and the second pluggable management module comprises a second set of at least one of one or more out-of-band management ports and one or more out-of-band management indicators. The computing device comprises at least one processing device comprising a processor coupled to a memory. The at least one processing device is configured to exchange, with the first pluggable management module, configuration information for the first set of the at least one of the one or more out-of-band management ports and the one or more out-of-band management indicators. The at least one processing device is also configured to exchange, with the second pluggable management module, configuration information for the second set of the at least one of the one or more out-of-band management ports and the one or more out-of-band management indicators. The at least one processing device is further configured to determine an operational status of one or more components of the computing device, and to provide, to at least one of the first pluggable management module and the second pluggable management module, out-of-band management information for controlling operation of the at least one of (i) the first set of the at least one of the one or more out-of-band management ports and the one or more out-of-band management indicators and (ii) the second set of the at least one of the one or more out-of-band management ports and the one or more out-of-band management indicators.

These and other illustrative embodiments include, without limitation, methods, apparatus, networks, systems and processor-readable storage media.

### BRIEF DESCRIPTION OF THE DRAWINGS

FIG. 1 is a block diagram of an information processing system configured for utilization of pluggable management modules in computing devices in an illustrative embodiment.

FIGS. 2A and 2B show views of pluggable management module field-replaceable units in an illustrative embodiment.

FIG. 3 shows a network switch configured for connection with pluggable management module field-replaceable units in an illustrative embodiment.

FIG. 4 shows a network switch configured for connection with pluggable management module field-replaceable units, where the network switch is mounted to rack posts and rails, in an illustrative embodiment.

FIG. 5 is a flow diagram of an exemplary process for utilization of pluggable management modules in computing devices in an illustrative embodiment.

FIGS. 6 and 7 show examples of processing platforms that may be utilized to implement at least a portion of an information processing system in illustrative embodiments.

### DETAILED DESCRIPTION

Illustrative embodiments will be described herein with reference to exemplary information processing systems and associated computers, servers, storage devices and other processing devices. It is to be appreciated, however, that embodiments are not restricted to use with the particular illustrative system and device configurations shown. Accordingly, the term “information processing system” as used herein is intended to be broadly construed, so as to encompass, for example, processing systems comprising cloud computing and storage systems, as well as other types of processing systems comprising various combinations of physical and virtual processing resources. An information processing system may therefore comprise, for example, at least one data center or other type of cloud-based system that includes one or more clouds hosting tenants that access cloud resources.

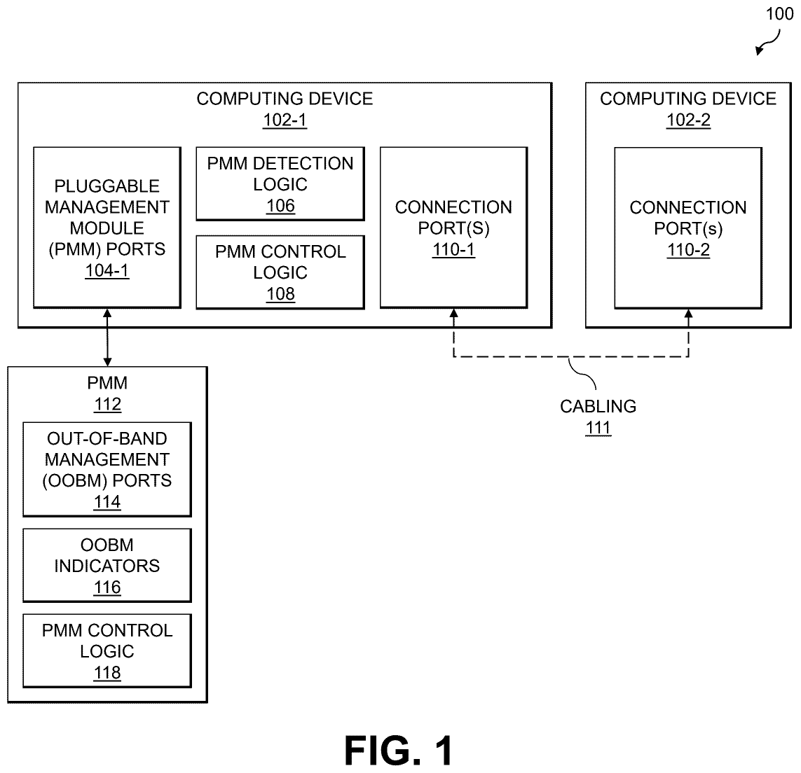

FIG. 1 shows an information processing system 100 configured in accordance with an illustrative embodiment. The information processing system 100 is assumed to be built on at least one processing platform and provides functionality for utilization of pluggable management modules (PMMs) in computing devices. The information processing system 100 includes computing devices 102-1 and 102-2 (collectively, computing devices 102). The computing device 102-1 includes one or more PMM ports 104-1 and one or more connection ports 110-1. The computing device 102-2 also includes one or more connection ports 110-2, with the connection ports 110-1 and 110-2 (collectively, connection ports 110) being interconnected via cabling 111. The cabling 111 may comprise, for example, direct attach copper (DAC), fiber cabling, etc.

The computing devices 102 may comprise physical hardware devices such as servers, storage systems, networking equipment, Internet of Things (IoT) devices, other types of processing and computing devices including desktops, laptops, etc. In some embodiments, at least one of the computing devices 102 is a network device such as a switch, where the network device may include multiple connection ports 110.

In the information processing system 100, a PMM 112 is configured for insertion into one or more of the PMM ports 104-1 of the computing device 102-1. The PMM 112 includes one or more out-of-band management (OOBM) ports 114 and one or more OOBM indicators 116. The OOBM ports 114 may comprise, for example, console ports, ethernet ports, universal serial bus (USB) ports, etc. The OOBM indicators 116 may comprise, for example, light-emitting diodes (LEDs) or other light-based indicators, beacons or other audible indicators, etc. The PMM 112 may be removably coupled to the PMM ports 104-1, such that the computing device 102-1 utilizes the OOBM functionality (e.g., OOBM ports 114 and OOBM indicators 116) as-needed (e.g., when configuring the computing device 102-1, when troubleshooting the computing device 102-1, etc.). The PMM 112 can therefore be removed and used for multiple different computing devices, or with different PMM ports of the same computing device at different times. Also, while FIG. 1 shows an embodiment with just a single PMM 112, it should be appreciated that multiple instances of the PMM 112 may be plugged into multiple distinct ones of the PMM ports 104-1. Such multiple instances of the PMM 112 may utilize different arrangements of OOBM ports 114 and OOBM indicators 116. For example, the computing device 102-1 may have a first one of the PMM ports 104-1 at a first (e.g., left) side of a front panel thereof and a second one of the PMM ports 104-1 at a second (e.g., right) side of the front panel thereof, with different instances of the PMM 112 being plugged into the first and second ones of the PMM ports 104-1 at the first and second sides of the front panel of the computing device 102-1. Various other examples are possible.

In some embodiments, the computing devices 102 are part of an information technology (IT) infrastructure that is operated by an enterprise, organization or other entity. As used herein, the term “enterprise system” is intended to be construed broadly to include any group of systems or other computing devices. For example, the computing devices 102 of the IT infrastructure may provide a portion of one or more enterprise systems. A given enterprise system may also or alternatively include various other computing devices or other types of IT assets. In some embodiments, an enterprise system includes one or more data centers, cloud infrastructure comprising one or more clouds, etc. A given enterprise system, such as cloud infrastructure, may host assets that are associated with multiple enterprises (e.g., two or more different businesses, organizations or other entities).

Although not explicitly shown in FIG. 1, one or more input-output devices such as keyboards, displays or other types of input-output devices may be used to support one or more user interfaces to the computing devices 102, as well as to support communication between these elements and other related systems and devices not explicitly shown.

The computing devices 102 and other elements of the information processing system 100 in the FIG. 1 embodiment are assumed to be implemented using at least one processing device. Each such processing device generally comprises at least one processor and an associated memory, and implements one or more functional modules or logic for controlling certain features of the information processing system 100. In the FIG. 1 embodiment, for example, the computing device 102-1 is assumed to comprise a processor and a memory which implement PMM detection logic 106 and PMM control logic 108. Similarly, the PMM 112 is assumed to comprise a processor and a memory which implement PMM control logic 118. The PMM detection logic 106 is configured to detect when the PMM 112 is plugged in to one of the PMM ports 104-1. The PMM control logics 108 and 118 are configured to exchange OOBM signaling or other information which is used to control or otherwise manage operation of the OOBM ports 114 and the OOBM indicators 116. For example, the PMM control logics 108 and 118 may drive the OOBM indicators 116 to provide various information (e.g., status, activity, etc.).

It is to be appreciated that the particular arrangement of the computing devices 102 and the PMM 112 illustrated in the FIG. 1 embodiment is presented by way of example only, and alternative arrangements can be used in other embodiments. As discussed above, for example, multiple instances of the PMM 112 may be removably coupled and connected with multiple PMM ports on the same or different computing devices.

The computing devices 102 and other portions of the system 100, as will be described in further detail below, may be part of cloud infrastructure.

The computing devices 102, the PMM 112 and other components of the information processing system 100 in the FIG. 1 embodiment are assumed to be implemented using at least one processing platform comprising one or more processing devices each having a processor coupled to a memory. Such processing devices can illustratively include particular arrangements of compute, storage and network resources.

The computing devices 102, the PMM 112, or components thereof or other components of the information processing system 100 in the FIG. 1 embodiment, may be implemented on respective distinct processing platforms, although numerous other arrangements are possible. The term “processing platform” as used herein is intended to be broadly construed so as to encompass, by way of illustration and without limitation, multiple sets of processing devices and associated storage systems that are configured to communicate over one or more networks. For example, distributed implementations of the system 100 are possible, in which certain components of the system reside in one data center in a first geographic location while other components of the system reside in one or more other data centers in one or more other geographic locations that are potentially remote from the first geographic location. Thus, it is possible in some implementations of the system 100 for computing devices 102, or portions or components thereof, to reside in different data centers. Numerous other distributed implementations are possible.

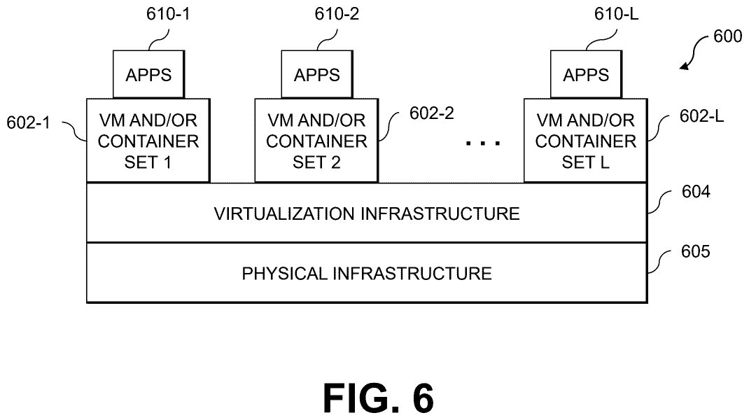

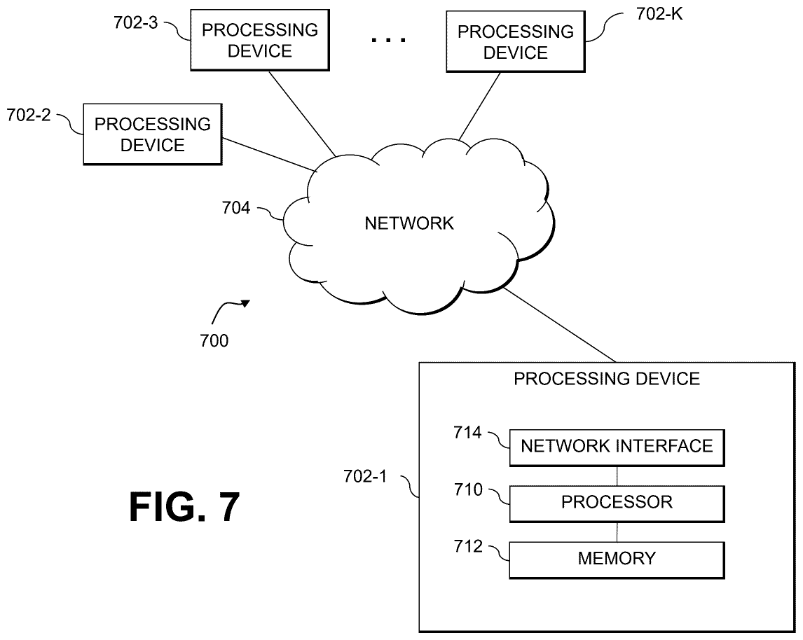

Additional examples of processing platforms utilized to implement components of the system 100 in illustrative embodiments will be described in more detail below in conjunction with FIGS. 6 and 7.

It is to be appreciated that these and other features of illustrative embodiments are presented by way of example only, and should not be construed as limiting in any way.

It is to be understood that the particular set of elements shown in FIG. 1 for utilization of PMMs in computing devices is presented by way of illustrative example only, and in other embodiments additional or alternative elements may be used. Thus, another embodiment may include additional or alternative systems, devices and other network entities, as well as different arrangements of modules and other components.

It is to be appreciated that these and other features of illustrative embodiments are presented by way of example only, and should not be construed as limiting in any way.

Network devices, such as network switches, may include network ports supporting a wide spectrum of data transfer speeds (e.g., 1G to 400G) to provide users with the widest possible range of connectivity options. “Super-Spine” network devices are further expected to see 800G-based deployments. Across product lines, network switches and other network devices support out-of-band management/monitoring (OOBM) capabilities through various ports and indicators (e.g., through Registered Jack-45 (RJ45) console and ethernet ports, micro-Universal Serial Bus (USB) console ports, USB-A ports, system light-emitting diodes (LEDs), stack identifier (ID) LEDs, other light-based visual indicators, etc.), where the ports and indicators may be located on either side of the switchports on a front panel of a network switch, or which may be split to the left and right sides of the switchports on the front panel of the network switch. In some cases, one or more OOBM ports and indicators may be on a back panel of the network switch (e.g., on the power supply unit (PSU) side), such as towards a middle of the back panel (e.g., in lieu of a fan tray).

OOBM ports are a feature of most network switches, network devices and other types of IT assets. The design of OOBM ports, however, has not changed across vendors for almost a decade. Conventional approaches for OOBM design, however, suffer from various technical challenges. For example, the OOBM functionality typically occupies a few square inches of precious front panel/faceplate space (e.g., when on the input/output (I/O) side), or which eliminates a fan (e.g., when on the PSU side) of a network switch. Further, a network processing unit (NPU) application-specific integrated circuit (ASIC) may be capable of a better port profile, and possibly additional ports, but the “real estate” on the front panel of the network switch and overall thermal performance (e.g., support for higher optics, etc.) may prevent support for such configurations. As another example, OOBM ports and indicators for network switches and other network devices as well as other types of IT assets may be fixed by the vendor during the design phase of each network switch, network device or other IT asset, and cannot be changed to adapt to changing needs or desires for OOBM capabilities.

Illustrative embodiments provide technical solutions for disaggregating OOBM functionality (e.g., OOBM ports and indicators) from the faceplate of a network switch, network device or other IT asset. In doing so, the technical solutions are able to provide various technical advantages, including better thermal performance (e.g., as switchports may be better spaced out for more air inlet), which will help in supporting higher power optics (e.g., including for PSU to I/O airflow configurations). Disaggregating the OOBM functionality may also allow for adding more switchports or other components to the front plate of a network switch, network device or other type of IT asset. In a network switch, for example, based on the NPU configuration it may be possible to provide more switchports with only a marginal increase in thermal footprint. The technical solutions also advantageously enable a more flexible design for OOBM functionality, including different types and numbers of ports and indicators. In some embodiments, the technical solutions may provide a choice of which types of OOBM ports and indicators are included on a per-switch, per-network device or per-IT asset basis depending on the needs of particular use cases. For example, the technical solutions may provide two or more ethernet ports which can be used in a bonding configuration, custom software-triggered LEDs or other types of indicators (e.g., including visual indicators, audible indicators, etc.), a Bluetooth low energy (BLE) console instead of a micro-USB console, customized beacon LEDs or audible beacons/alarms, choice of USB 2.0, USB 3.0, USB-C, etc.

Illustrative embodiments provide a pluggable management module (PMM) that may be inserted into a designated portion of a faceplate of a network switch or other type of network device or IT asset. In some embodiments, the PMM is configured for insertion into a slot at the left and/or right edges of the faceplate of the network switch. The PMM is designed with a core module that is aligned away from the faceplate of the network switch when plugged in, and is configured to sit in front of rack front posts and thumb screws when the network switch is mounted to a rack. Advantageously, the PMM may have a design which evolves orthogonal to improvements in the network switch or other type of network device or IT asset, and enables software-defined and customized OOBM features and functionality.

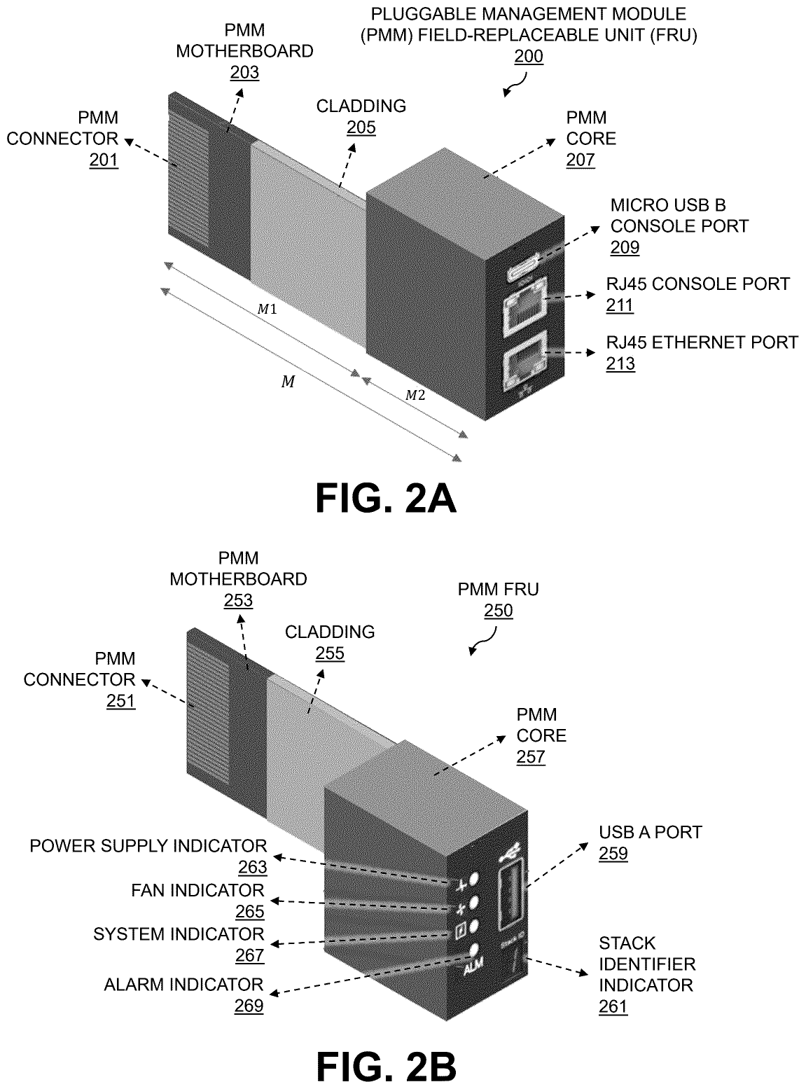

FIGS. 2A and 2B show PMM field-replaceable units (FRUs) 200 and 250, respectively. The PMM FRU 200 is designed for plugging into a “right” side of a network switch or other type of network device or IT asset, while the PMM FRU 250 is designed for plugging into a “left” side of the network switch or other type of network device or IT asset. The PMM FRU 200 includes a PMM connector 201, a PMM motherboard 203, cladding 205, a PMM core 207, a micro USB B console port 209, an RJ45 console port 211, and an RJ45 ethernet port 213. The RJ45 console port 211 and the RJ45 ethernet port 213 may include ethernet link status and activity LEDs or other light-based indicators). The PMM FRU 250 includes a PMM connector 251, a PMM motherboard 253, cladding 255, a PMM core 257, a USB A port 259, a stack ID indicator 261, a power supply indicator 263, a fan indicator 265, a system indicator 267 and an alarm indicator 269. The stack ID indicator 261, the power supply indicator 263, the fan indicator 265, the system indicator 267 and the alarm indicator 269 may comprise LEDs or other light-based indicators. One or more of such indicators may also or alternatively include a beacon or other audible indicator.

The PMM FRUs 200, 250 house OOBM ports and indicators (e.g., replacing what would be present on a typical network switch or other network device or IT asset, for example). The claddings 205, 255 cover portions of the PMM motherboards 203, 253 (e.g., the ports which would be visible externally when the PMM FRUs 200 and 250 are plugged in). The segment farthest from the PMM cores 207, 257 include the PMM connectors 201, 251. The overall length of the PMM FRU 200 (and, similarly, the PMM FRU 250) is denoted M, which includes a length M1 which is the length of the PMM motherboards 203, 253 outside the PMM cores 207, 257, and a length M2 which is the length of the PMM cores 207, 257. Once plugged in, the PMM cores 207, 257 and part of the cladding 205, 255 covered segments protrude outside the network switch or other network device or IT asset to which the PMM FRUs 200, 250 are plugged in. The height of the PMM FRUs 200, 250 may be a few millimeters (mm) less than 1 Rack Unit (RU) or 2RU.

It should further be noted that the particular OOBM ports and indicators which are shown on the “right” PMM FRU 200 and the “left” PMM FRU 250 are presented by way of example only. Any desired combination of OOBM ports and indicators may be included on either the “right” PMM FRU 200 or the “left” PMM FRU 250, all of the desired OOBM ports and indicators may be included in a single PMM FRU, etc. For example, the RJ45 console port 211 and the micro USB B console port 209 may be on the “left” PMM FRU 250 while the USB A port 259 may be on the “right” PMM FRU 200. Also, various other types of OOBM ports and indicators may be used, such as 2 RJ45 ethernet ports that can be used in a bonding configuration, custom general purpose input/output (GPIO) ports, software-defined LEDs or other-light based indicators, a Bluetooth Low Energy (BLE) console, one or more audible beacons or alarms, USB 3.0 ports, USB-C ports, etc.

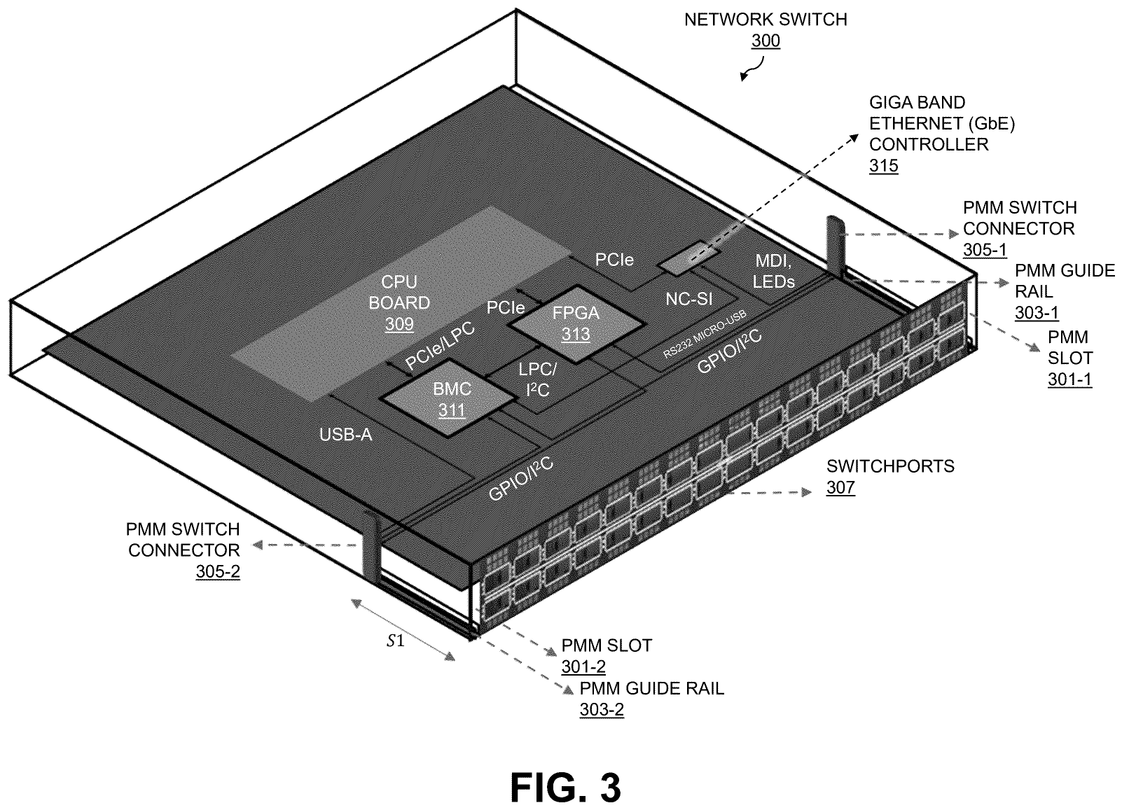

FIG. 3 shows a network switch 300 configured to support the use of PMMs. The network switch 300 includes PMM slots 301-1 and 301-2 (collectively, PMM slots 301) including PMM guide rails 303-1 and 303-2 (collectively, PMM guide rails 303) and PMM switch connectors 305-1 and 305-2 (collectively, PMM switch connectors 305). The PMM slots 301-1 and 301-2 are at the left and right edges of the front of the network switch 300 (e.g., where the front is where the switchports 307 of the network switch 300 are located). The network switch 300 also includes a switch board including a CPU board 309, a baseboard management controller (BMC) 311, a field-programmable gate array (FPGA) 313, and a giga band ethernet (GbE) controller 315. FIG. 3 shows specific examples of interfaces or links which may be used for communication among the various components of the switch board and the PMM switch connectors 305, though it should be noted that these interfaces are presented by way of example only for the specific distribution of OOBM ports and indicators shown for the PMM FRUs 200 and 250. The CPU board 309 may have a peripheral component interconnect express (PCIe) or a low pin count (LPC) link to the BMC 311, and the CPU board 309 may have a PCIe link to the FPGA 313. The BMC 311 and the FPGA 313 may be connected over an LPC or inter-integrated circuit (I2C) link. The GbE controller 315 connects to the CPU board 309 via PCIe, and may have a network controller sideband interface (NC-SI) link to the BMC 311. USB-A is driven by the CPU board 309 to the PMM switch connector 305-1. The system LEDs may be driven by the BMC 311 or the FPGA 313 utilizing GPIO/I2C links or interfaces. Media-dependent interface (MDI) and ethernet port LEDs are driven by the GbE controller 315.

The network switch 300, instead of having OOBM ports and indicators on the right or left sides of the front panel (e.g., where the switchports 307 are), has the PMM slots 301 at the right and left sides of the front panel. The PMM slots 301 may be a couple of millimeters wide enabling the PMM FRUs 200 and 250 to be plugged into the PMM slot 301-1 and the PMM slot 301-2, respectively. The PMM guide rails 303 are clamped to the base of the network switch 300, such that when the PMM FRUs 200 and 250 are plugged in, the PMM connectors 201, 251 and PMM motherboards 203, 253 (including portions of the cladding 205, 255 covered regions) traverse along the PMM guide rails 303 until the PMM connectors 201, 251 latch to the PMM switch connectors 305. The length of each of the PMM guide rails 303 is S1. When the PMM FRUs 200, 250 are plugged in, a part of the cladding 205, 255 covered regions lie within the housing of the network switch 300. The PMM switch connectors 305 are clamped to the motherboard of the network switch 300, and OOBM port and indicator signals from the CPU board 309, the BMC 311, the FPGA 313 and the GbE controller 315 are terminated on the PMM switch connectors 305.

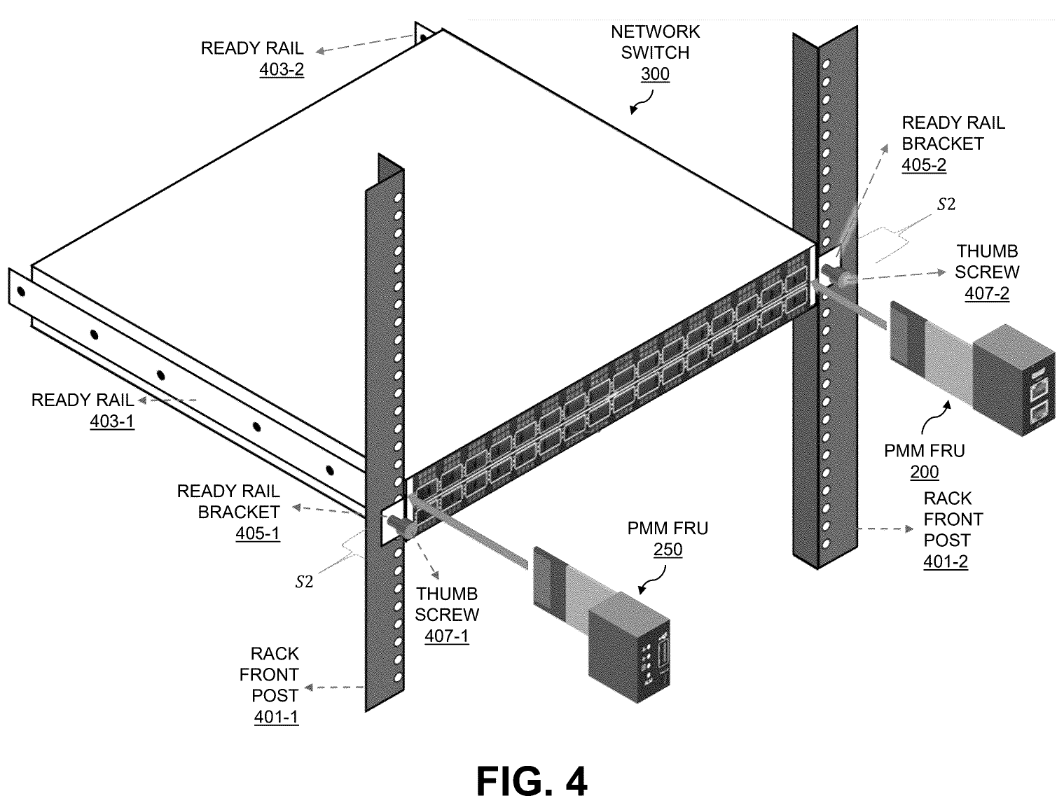

FIG. 4 illustrates plugging the PMM FRUs 200 and 250 into the PMM slots 301 of the network switch 300, where the network switch 300 is attached to rack front posts 401-1 and 401-2 (collectively, rack front posts 401) and ready rails 403-1 and 403-2 (collectively, ready rails 403) which are attached to ready rail brackets 405-1 and 405-2 (collectively, ready rail brackets 405). The network switch 300 may be installed using the ready rails 403, or an L-bracket in a four post rack. Irrespective of the rack or other installation type, the left and right outer rails of the network switch 300 are clamped to the rack front posts 401 and tightened to the front side of the rack front posts 401 utilizing thumb screws 407-1 and 407-2 (collectively, thumb screws 407). The thumb screws 407 (even in an at least partially unscrewed position) may project outside the rack by a length S2. The PMM FRU 200 is plugged into the PMM slot 301-1 on the network switch 300, while the PMM FRU 250 is plugged into the PMM slot 301-2 on the network switch 300. The PMM motherboards 203, 253 of the PMM FRUs 200, 250 traverse along the PMM guide rails 303 until the PMM connectors 201, 251 are plugged into the PMM switch connectors 305. When fully plugged in, a part of the cladding 205, 255 covered regions on the PMM motherboards 203, 253 may be outside the housing of the network switch 300. The length of the PMM motherboards 203, 253 outside the PMM cores 207, 257, denoted M1, is greater than the sum of S1 and S2. Essentially, when the PMM FRUs 200, 250 are plugged in, there is sufficient clearance behind the PMM cores 207, 257 to accommodate the thumb screws 407 of the rack. The PMM FRUs 200, 250 may be plugged into and out of the network switch 300 as needed or as desired (e.g., plugged in after installation of the network switch 300 in a rack, and unplugged prior to uninstallation of the network switch 300 from the rack).

In some embodiments, PMMs may be used for “greenfield” deployments, such as deployments of network switches with 100G and above switchports. Various contemporary rack designs (e.g., open frame, cabinet, etc.) have characteristics such as: the ability to attach a cable manager on a side of the rack; sufficient front clearance from the network switch faceplate to the cabinet door or the front plane/edge of the rack (e.g., if open); and depth cable managers configured to accommodate for a worst-case minimum bend radius (e.g., for Quad Small Form Factor Pluggable Double Density (QFSP-DD) 5 meters, around 3.1 inches). The PMM FRUs may protrude out by about 1.5 to 2 inches, which should be sufficient even considering the bend radius of ethernet and console port cables for ethernet and console ports of a PMM FRU (e.g., which, for Cat6 options, are available with a bend radius of 0.6 inches). In the case of active optical cable (AOC) or other optics, it should be ensured that the cable length is a few inches longer. In a typical 24 inch rack, the extra width available on each side is about 2.5 inches. The core width of the PMM FRUs (e.g., the PMM cores 207, 257 for PMM FRUs 200, 250) may be between 0.75 and 1 inches wide, thus allowing for an extra 1.5 inches of clearance on each side.

In some embodiments, the PMM FRUs are also designed to account for the possibility of technicians or other personnel accidentally hitting PMM FRUs which are plugged into PMM ports of a computing device while installing or uninstalling other equipment nearby to the computing device. Specifically, for open frame racks which may not have sufficient width clearance on rack posts, cable managers may act as natural barriers that can prevent accidental hitting from adjacent rack installs. Technicians and other personnel should be careful and made aware of the presence of PMM FRUs in any adjacent rack during install or while replacing cables/transceivers that are closest to where PMM FRUs are plugged in (e.g., switchports at left and right edges of a network switch). Installation guides may be used to provide necessary guidance to the technicians and other personnel.

Further, while there is a choice of using multiple PMM FRUs (e.g., such as using both the PMM FRUs 200, 250), this is not a requirement. A single PMM FRU may accommodate all needed OOBM ports and/or OOBM indicators (e.g., a single PMM FRU may accommodate RJ45 ethernet, RJ45 console and one or more USB ports as well as any desired LEDs or other indicators).

In some embodiments, a PMM FRU may be implemented using a USB interface where the PMM connectors 201, 251 are USB connectors to simplify and standardize interfaces to the various OOBM ports and indicators (e.g., USB, LEDs, ethernet, stack, etc.). In other embodiments, custom connectors may be used with dedicated lines for different OOBM ports and indicators. Native or dedicated lines may be used so that there is not change to the software layers of the network switch or other type of network device or IT asset to which PMM FRUs are plugged in (e.g., the BMC, basic input/output system (BIOS), network operating system (NOS), etc.), and so there is no need to introduce software layers or logic on the PMM FRUs.

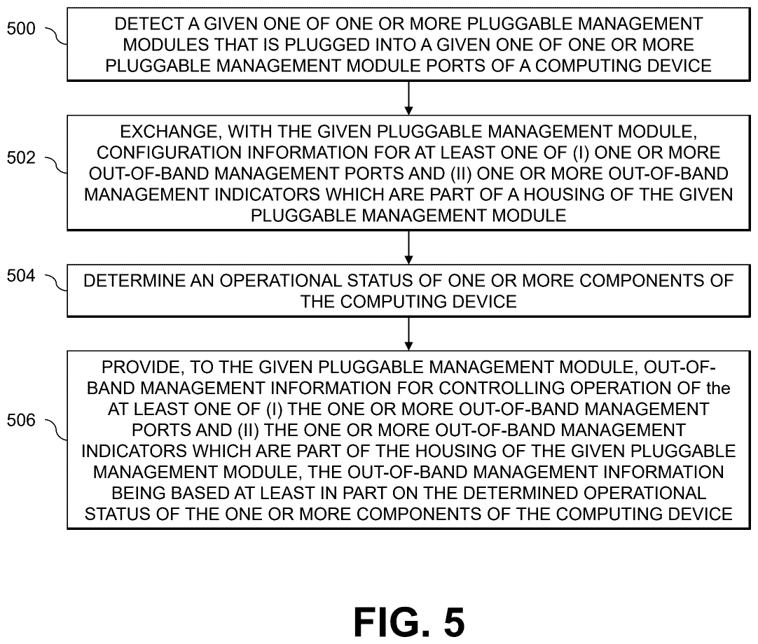

An exemplary process for utilization of PMMs in computing devices will now be described in more detail with reference to the flow diagram of FIG. 5. It is to be understood that this particular process is only an example, and that additional or alternative processes for utilization of PMMs in computing devices may be used in other embodiments.

In this embodiment, the process includes steps 500 through 506. These steps are assumed to be performed by the computing device 102-1 and/or the PMM 112 utilizing the PMM detection logic 106 and the PMM control logics 108 and 118. The process begins with step 500, detecting a given PMM (e.g., PMM 112) that is plugged into a given PMM port (e.g., one of the PMM ports 104-1) of a computing device (e.g., computing device 102-1, which may be a network switch or other type of network device or IT asset). The given PMM port may be arranged on a front panel of a housing of the computing device. In some embodiments, the computing device includes multiple PMM ports, such as a first PMM port arranged on a first edge of the front panel of the housing of the computing device and a second PMM port arranged on a second edge of the front panel of the housing of the computing device. Different PMM instances may be plugged into different ones of the multiple PMM ports at different times (e.g., on an as-need basis for performing configuration and management of the computing device).

The given PMM may include a housing comprising one or more OOBM ports and/or one or more OOBM indicators, and may include a connector coupled to the housing, where the connector is configured for operable interconnection with the given PMM port of the computing device. The given PMM may include a circuit board extending between the connector and the housing, where at least a portion of the circuit board between the housing and the connector is covered by a cladding. When the connector is plugged into the PMM port of the computing device, at least a portion of the cladding may extend outside a housing of the computing device. The circuit board may be coupled to the one or more OOBM ports and the one or more OOBM indicators. The one or more OOBM ports may comprise at least one of a console port, an ethernet port, and a USB port. The one or more OOBM indicators may comprise at least one of one or more light-based indicators (e.g., one or more LEDs) and one or more audible indicators.

In step 502, configuration information for at least one of one or more OOBM ports (e.g., OOBM ports 114) and one or more OOBM indicators (e.g., OOBM indicators 116) which are part of a housing of the given PMM is exchanged between the computing device and the given PMM. This may include the computing device obtaining an inventory of the OOBM ports and/or OOBM indicators which are available or part of the housing of the given PMM. Where multiple PMM instances are plugged into multiple different PMM ports of the computing device, step 502 may include exchanging configuration information for each of the plugged-in PMM instances, where each of the plugged-in PMM instances may include different sets of OOBM ports and/or OOBM indicators.

In step 504, an operational status of one or more components of the computing device is determined. The operational status may comprise, for example, information associated with one or more switchports of the computing device, link state and status for links established utilizing the one or more switchports of the computing device, power supply information, fan status information, system identification information, status or activity information for the OOBM ports of the given PMM, etc.

In step 506, OOBM information is provided to the given PMM, where the OOBM information is used for controlling at least one of the OOBM ports or OOBM indicators of the given PMM based at least in part on the determined operational status of the one or more components of the computing device.

A network switch or other type of network device or IT asset, instead of having OOBM ports and indicators on a front or back panel thereof, is configured with slots for PMMs, such that PMM motherboards of the PMMs may traverse along PMM guide rails clamped to the base of the network switch or other type of network device or IT asset and get latched to connectors which are attached to the motherboard of the network switch or other type of network device or IT asset, which terminates management port and indicator signals from a controller (e.g., a CPU, BMC, FPGA or GbE controller) of the network switch or other type of network device or IT asset. Such management port and indicator signals may be used, by way of example, for console, micro USB-B, ethernet, system and stacking LEDs. When the PMMs are plugged in, PMM cores project to the left or right edges of the network switch or other type of network device or IT asset, and may rest in front of rack thumb screws thereby freeing up front panel space on the network switch or other type of network device or IT asset to facilitate better airflow, thermals and more switchports or other components. It should be noted that while various embodiments are described with respect to use of PMMs for network switches, this is not a requirement. PMMs may be used for other types of network devices, or for other types of IT assets (e.g., servers, storage systems, etc.) for which it is desired to disaggregate OOBM ports and indicators from the housing thereof (e.g., front, side, back, top and/or bottom panels thereof).

The technical solutions may be implemented by various hardware vendors for creating PMMs for use with different types of network switches, network devices or other IT assets. The technical solutions advantageously free up precious front panel or other housing space for better airflow/thermal performance, to allow for more switchports or other components (including increased spacing between existing switchports or other components), etc. The technical solutions further advantageously enable disaggregation of OOBM ports and indicators from network switches, network devices or other IT assets to facilitate custom OOBM port and indicator options. Decoupling the OOBM ports and indicators paves the way for flexible PMMs that provide improved user experience and convenience, including functionality such as BLE console, custom LEDs, system beacons, extra console/USB/ethernet ports, etc.

It is to be appreciated that the particular advantages described above and elsewhere herein are associated with particular illustrative embodiments and need not be present in other embodiments. Also, the particular types of information processing system features and functionality as illustrated in the drawings and described above are exemplary only, and numerous other arrangements may be used in other embodiments.

Illustrative embodiments of processing platforms utilized to implement functionality for utilization of PMMs in computing devices will now be described in greater detail with reference to FIGS. 6 and 7. Although described in the context of system 100, these platforms may also be used to implement at least portions of other information processing systems in other embodiments.

FIG. 6 shows an example processing platform comprising cloud infrastructure 600. The cloud infrastructure 600 comprises a combination of physical and virtual processing resources that may be utilized to implement at least a portion of the information processing system 100 in FIG. 1. The cloud infrastructure 600 comprises multiple virtual machines (VMs) and/or container sets 602-1, 602-2, . . . 602-L implemented using virtualization infrastructure 604. The virtualization infrastructure 604 runs on physical infrastructure 605, and illustratively comprises one or more hypervisors and/or operating system level virtualization infrastructure. The operating system level virtualization infrastructure illustratively comprises kernel control groups of a Linux operating system or other type of operating system.

The cloud infrastructure 600 further comprises sets of applications 610-1, 610-2, . . . 610-L running on respective ones of the VMs/container sets 602-1, 602-2, . . . 602-L under the control of the virtualization infrastructure 604. The VMs/container sets 602 may comprise respective VMs, respective sets of one or more containers, or respective sets of one or more containers running in VMs.

In some implementations of the FIG. 6 embodiment, the VMs/container sets 602 comprise respective VMs implemented using virtualization infrastructure 604 that comprises at least one hypervisor. A hypervisor platform may be used to implement a hypervisor within the virtualization infrastructure 604, where the hypervisor platform has an associated virtual infrastructure management system. The underlying physical machines may comprise one or more distributed processing platforms that include one or more storage systems.

In other implementations of the FIG. 6 embodiment, the VMs/container sets 602 comprise respective containers implemented using virtualization infrastructure 604 that provides operating system level virtualization functionality, such as support for Docker containers running on bare metal hosts, or Docker containers running on VMs. The containers are illustratively implemented using respective kernel control groups of the operating system.

As is apparent from the above, one or more of the processing modules or other components of system 100 may each run on a computer, server, storage device or other processing platform element. A given such element may be viewed as an example of what is more generally referred to herein as a “processing device.” The cloud infrastructure 600 shown in FIG. 6 may represent at least a portion of one processing platform. Another example of such a processing platform is processing platform 700 shown in FIG. 7.

The processing platform 700 in this embodiment comprises a portion of system 100 and includes a plurality of processing devices, denoted 702-1, 702-2, 702-3, . . . 702-K, which communicate with one another over a network 704.

The network 704 may comprise any type of network, including by way of example a global computer network such as the Internet, a WAN, a LAN, a satellite network, a telephone or cable network, a cellular network, a wireless network such as a WiFi or WiMAX network, or various portions or combinations of these and other types of networks.

The processing device 702-1 in the processing platform 700 comprises a processor 710 coupled to a memory 712.

The processor 710 may comprise a microprocessor, a microcontroller, an application-specific integrated circuit (ASIC), a field-programmable gate array (FPGA), a central processing unit (CPU), a graphical processing unit (GPU), a tensor processing unit (TPU), a video processing unit (VPU) or other type of processing circuitry, as well as portions or combinations of such circuitry elements.

The memory 712 may comprise random access memory (RAM), read-only memory (ROM), flash memory or other types of memory, in any combination. The memory 712 and other memories disclosed herein should be viewed as illustrative examples of what are more generally referred to as “processor-readable storage media” storing executable program code of one or more software programs.

Articles of manufacture comprising such processor-readable storage media are considered illustrative embodiments. A given such article of manufacture may comprise, for example, a storage array, a storage disk or an integrated circuit containing RAM, ROM, flash memory or other electronic memory, or any of a wide variety of other types of computer program products. The term “article of manufacture” as used herein should be understood to exclude transitory, propagating signals. Numerous other types of computer program products comprising processor-readable storage media can be used.

Also included in the processing device 702-1 is network interface circuitry 714, which is used to interface the processing device with the network 704 and other system components, and may comprise conventional transceivers.

The other processing devices 702 of the processing platform 700 are assumed to be configured in a manner similar to that shown for processing device 702-1 in the figure.

Again, the particular processing platform 700 shown in the figure is presented by way of example only, and system 100 may include additional or alternative processing platforms, as well as numerous distinct processing platforms in any combination, with each such platform comprising one or more computers, servers, storage devices or other processing devices.

For example, other processing platforms used to implement illustrative embodiments can comprise converged infrastructure.

It should therefore be understood that in other embodiments different arrangements of additional or alternative elements may be used. At least a subset of these elements may be collectively implemented on a common processing platform, or each such element may be implemented on a separate processing platform.

As indicated previously, components of an information processing system as disclosed herein can be implemented at least in part in the form of one or more software programs stored in memory and executed by a processor of a processing device. For example, at least portions of the functionality for utilization of PMMs in computing devices as disclosed herein are illustratively implemented in the form of software running on one or more processing devices.

It should again be emphasized that the above-described embodiments are presented for purposes of illustration only. Many variations and other alternative embodiments may be used. For example, the disclosed techniques are applicable to a wide variety of other types of information processing systems, IT assets, etc. Also, the particular configurations of system and device elements and associated processing operations illustratively shown in the drawings can be varied in other embodiments. Moreover, the various assumptions made above in the course of describing the illustrative embodiments should also be viewed as exemplary rather than as requirements or limitations of the disclosure. Numerous other alternative embodiments within the scope of the appended claims will be readily apparent to those skilled in the art.

What is claimed is:

1. An apparatus comprising:
a housing comprising at least one of (i) one or more out-of-band management ports and (ii) one or more out-of-band management indicators;
a connector coupled to the housing, the connector configured for operable interconnection with a pluggable management module port of a computing device; and
at least one processing device comprising a processor coupled to a memory;
the at least one processing device being configured:
to exchange, with the computing device, configuration information for said at least one of (i) the one or more out-of-band management ports and (ii) the one or more out-of-band management indicators;
to receive, from the computing device, out-of-band management information for controlling operation of said at least one of (i) the one or more out-of-band management ports and (ii) the one or more out-of-band management indicators, the out-of-band management information being based at least in part on a determined operational status of one or more components of the computing device; and
to control, based at least in part on the received out-of-band management information, operation of said at least one of (i) the one or more out-of-band management ports and (ii) the one or more out-of-band management indicators.

2. The apparatus of claim 1 further comprising a circuit board extending between the connector and the housing, wherein at least a portion of the circuit board between the housing and the connector is covered by a cladding.

3. The apparatus of claim 2 wherein when the connector is plugged into the pluggable management module port of the computing device, at least a portion of the cladding extends outside a housing of the computing device.

4. The apparatus of claim 2 wherein the circuit board is coupled to the connector, said at least one of (i) the one or more out-of-band management ports and (ii) the one or more out-of-band management indicators, and the at least one processing device.

5. The apparatus of claim 1 wherein the one or more out-of-band management ports comprise at least one of a console port, an ethernet port, and a universal serial bus port.

6. The apparatus of claim 1 wherein the one or more out-of-band management indicators comprise at least one of one or more light-based indicators and one or more audible indicators.

7. The apparatus of claim 6 wherein the one or more light-based indicators comprise one or more light-emitting diodes.

8. The apparatus of claim 1 wherein the housing comprises (i) the one or more out-of-band management ports and (ii) the one or more out-of-band management indicators.

9. The apparatus of claim 1 wherein exchanging the configuration information comprises providing to the computing device an inventory of said at least one of (i) the one or more out-of-band management ports and (ii) the one or more out-of-band management indicators which are part of the housing of the apparatus.

10. An apparatus comprising:
one or more pluggable management module ports configured for operable interconnection with one or more pluggable management modules; and
at least one processing device comprising a processor coupled to a memory;
the at least one processing device being configured:
to detect a given one of the one or more pluggable management modules that is plugged into a given one of the one or more pluggable management module ports;
to exchange, with the given pluggable management module, configuration information for at least one of (i) one or more out-of-band management ports and (ii) one or more out-of-band management indicators which are part of a housing of the given pluggable management module;
to determine an operational status of one or more components of the apparatus; and
to provide, to the given pluggable management module, out-of-band management information for controlling operation of said at least one of (i) the one or more out-of-band management ports and (ii) the one or more out-of-band management indicators which are part of the housing of the given pluggable management module, the out-of-band management information being based at least in part on the determined operational status of the one or more components of the apparatus.

11. The apparatus of claim 10 wherein the one or more pluggable management module ports are arranged on a front panel a housing of the apparatus.

12. The apparatus of claim 11 wherein the one or more pluggable management module ports comprise a first pluggable management module port arranged on a first edge of the front panel of the housing of the apparatus and a second pluggable management module port arranged on a second edge of the front panel of the housing of the apparatus.

13. The apparatus of claim 10 wherein exchanging the configuration information comprises receiving, from the given pluggable management module, an inventory of said at least one of (i) the one or more out-of-band management ports and (ii) the one or more out-of-band management indicators which are part of the housing of the given pluggable management module.

14. The apparatus of claim 10 wherein the determined operational status comprises an operation state of the one or more components of the apparatus.

15. The apparatus of claim 14 wherein the one or more components of the apparatus comprise at least one of a power supply and one or more fans.

16. A system comprising:
a computing device comprising two or more pluggable management module ports;
a first pluggable management module configured for insertion into a first one of the two or more pluggable management module ports, the first pluggable management module comprising a first set of at least one of one or more out-of-band management ports and one or more out-of-band management indicators; and
a second pluggable management module configured for insertion into a second one of the two or more pluggable management module ports, the second pluggable management module comprising a second set of at least one of one or more out-of-band management ports and one or more out-of-band management indicators;
wherein the computing device comprises at least one processing device comprising a processor coupled to a memory, the at least one processing device being configured:
to exchange, with the first pluggable management module, configuration information for the first set of said at least one of the one or more out-of-band management ports and the one or more out-of-band management indicators;
to exchange, with the second pluggable management module, configuration information for the second set of said at least one of the one or more out-of-band management ports and the one or more out-of-band management indicators;
to determine an operational status of one or more components of the computing device; and
to provide, to at least one of the first pluggable management module and the second pluggable management module, out-of-band management information for controlling operation of said at least one of (i) the first set of said at least one of the one or more out-of-band management ports and the one or more out-of-band management indicators and (ii) the second set of said at least one of the one or more out-of-band management ports and the one or more out-of-band management indicators.

17. The system of claim 16 wherein the computing device comprises a network switch.

18. The system of claim 16 wherein the two or more pluggable management module ports are arranged on a front panel a housing of the computing device.

19. The system of claim 18 wherein the first pluggable management module port is arranged on a first edge of the front panel of the housing of the computing device and the second pluggable management module port is arranged on a second edge of the front panel of the housing of the computing device.

20. The system of claim 16 the first set of said at least one of the one or more out-of-band management ports and the one or more out-of-band management indicators is different than the second set of said at least one of the one or more out-of-band management ports and the one or more out-of-band management indicators.
